(19) United States
(12) Patent Application Publication
(10) Pub. No.: US 2006/0068061 A1
(43) Pub. Date: Mar. 30, 2006

(54) Method of producing soybean-dairy food

(75) Inventors: Takeshi Nakazawa, Nagano-shi (JP); Kumiko Shimazaki, Nagano-shi (JP); Chie Aizawa, Nagano-shi (JP); Noriyoshi Ichijo, Nagano-shi (JP)

Correspondence Address: BIRCH STEWART KOLASCH & BIRCH, PO BOX 747, FALLS CHURCH, VA, 22040-0747, US

(73) Assignee: Marukome Co., Ltd.

(21) Appl. No.: 11/017,807

(22) Filed: Dec. 22, 2004

(30) Foreign Application Priority Data
Sep. 28, 2004 (JP) 2004-281032

(51) Int. Cl. A23L 1/20

(52) U.S. Cl. 426/46

(57) ABSTRACT

The method is capable of easily producing soybean-dairy food, which can be well digested and absorbed in human bodies. The method comprises the steps of: mixing koji into soybean milk; and hydrolyzing components of the soybean milk with a koji-derived enzyme.

### BACKGROUND OF THE INVENTION

The present invention relates to a method of producing soybean-dairy food, e.g., soybean milk, soybean milk yogurt, and a method of processing the soybean-dairy food.

Soybean milk includes healthy components, e.g., high quality vegetable protein, isoflavone capable of preventing bone-thinning osteoporosis. These days, we pay attention to our health, so soybean milk is now regarded as functional food.

However, soybean milk has unique flavor, e.g., grassy smell and taste, bitter taste, so some people dislike soybean milk. Thus, these days, many soybean milk drinks, to which sweeteners, flavors, fruits, etc. are added, are produced so as to spread soybean milk.

By adding sweeteners, etc., taste of soybean milk can be improved, and soybean milk is spread as a drink. Further, if nutritious soybean milk can be well digested and absorbed in human bodies, it will be widely used as soybean-dairy food, e.g., sports drinks, health foods, nutritious supplements. Commercial value of the soybean-dairy food can be increased.

### SUMMARY OF THE INVENTION

The inventors of the present invention found that the unique flavor of soybean milk can be improved by treating soybean milk or mashed soybeans with koji, soybean milk is made sweeter by sweetness of koji, and polymer components of soybean milk are formed into low-molecular components so that they can be well digested and absorbed in human bodies.

An object of the present invention is to provide a method of easily producing soybean-dairy food, which can be well digested and absorbed in human bodies.

Another object is to provide a method of processing the soybean-dairy food.

To achieve the objects, the present invention has following structures.

Namely, the method of producing soybean-dairy food comprises the steps of:

mixing koji into soybean milk; and

hydrolyzing components of the soybean milk with a koji-derived enzyme.

Another method comprises the steps of:

adding koji to mashed soybeans;

hydrolyzing components of the mashed soybeans with a koji-derived enzyme; and

removing insoluble components.

Especially, the hydrolyzing step is performed under the following conditions:

amount of the koji to total amount is 1-50 wt %;

temperature is 30-80° C.;

time of treatment is 0.5-8 hours; and

a pH value is 5-8.

Each of the methods may further comprise the step of heating for 3-60 seconds at 120-150° C. so as to deactivate the enzyme and sterilize bacteria.

Further, the method of processing soybean-dairy food comprises the steps of:

mixing dairy food into the soybean-dairy food processed by the above described method;

inoculating lactic acid bacteria to the mixture; and

fermenting the mixture.

By the present invention, the soybean-dairy food, which is well digested and absorbed in human bodies, can be easily produced. The soybean-dairy food has many functions, so it can be widely used in many fields.

### DETAILED DESCRIPTION OF THE EMBODIMENTS

Preferred embodiments of the present invention will now be described in detail.

The method of producing soybean-dairy food is characterized by the steps of: mixing koji into soybean milk; and hydrolyzing components of the soybean milk with a koji-derived enzyme.

Soybean milk is a white liquid produced by the steps of: soaking soybeans in water; mashing the soybeans: heating the mashed soybeans; and removing insoluble components, e.g., bean curd refuse, from the mashed soybeans by, for example, filtering. Plenty of functional components, e.g., soybean-derived protein, isoflavone, are included in soybean milk.

When soybean milk having good flavor is used as a material, delicious soybean-dairy foods can be manufactured. Soybean milk, which is made by an ordinary method, may be used as the material of the soybean-dairy food. Preferably, soybean milk made from soybeans, which has been removed seed coat and hypocotyl to improve flavor or which has been heated to deactivate enzymes, is used so as to manufacture delicious soybean-dairy foods having less grassy smell and bitter taste.

Koji is made by growing koji mold in a medium made from cereal grains or beans. Many kinds of koji, e.g., rice koji, barley koji, bean koji, soy sauce koji, can be employed. One or a plurality of kinds of the koji are selected. Especially, the rice koji is a preferable one having no bad flavor.

Koji produced by growing koji mold is a lump of enzymes produced by koji mold. The koji includes many useful enzymes, e.g., amylase, protease, lipase, cellulase, hemicellulase, phytase, glucosidase. Note that, preferable koji mold are Aspergillus.

The koji is mixed into soybean milk so as to make a koji-derived enzyme affect the soybean milk under prescribed conditions and hydrolyze components of the soybean milk. The conditions are an amount of the enzyme, temperature and time of treatment, and a pH value. Further, texture and flavor of the soybean-dairy food made from the soybean milk are considerably influenced by the conditions.

The preferable amount of the enzyme is 1-50 wt % to the total amount. When the amount of the koji is increased, sweetness of the soybean-dairy food increases. On the other hand, when the amount of the koji is reduced, the sweetness of the soybean-dairy food is reduced, so the soybean-dairy food, e.g., soybean milk, has clear taste.

The preferable temperature of the treatment is 30-80° C.; more preferable temperature for activating the koji-derived enzyme is 40-60° C.

The preferable time of the treatment is 0.5-8 hours. If it is shorter than 0.5 hours, the soybean milk cannot fully hydrolyzed; if it is longer than 8 hours, unwanted bacteria exceedingly grow in the soybean milk.

The preferable pH value is 5-8. It may be adjusted by adding a pH adjusting agent to the soybean milk, or adding the pH adjusting agent to the mashed soybeans, which is a material of the soybean milk.

By adding the koji to the soybean milk and hydrolyzing the soybean milk with the koji-derived enzyme, the flavor of the soybean milk (soybean-dairy food) can be improved and the sweetness of the koji can be added to the soybean milk. Therefore, the soybean milk easy to drink can be produced. Further, polymer components of the soybean milk are formed into low-molecular components so that they can be well digested and absorbed in human bodies.

Namely, starch included in a medium, e.g., cereal grains, beans, of koji mold is converted into sugar, e.g., glucose, by amylase produced by the koji mold, so that the koji-derived sugar sweetens the soybean-dairy food.

In the soybean milk, isoflavone exists as glycoside, which is aglycon with sugar. By adding β-glucosidase or a koji-derived enzyme to the glycoside, the aglycon solely leaves so that the aglycon can be easily absorbed in human bodies.

When koji-derived protease works to protein included in the soybean milk, amino acid and peptide are produced. In comparison with intacted protein, the amino acid and peptide can be easily digested and absorbed, so that they are effective in recuperation, activation of immune system, beauty, etc. Therefore, the amino acid and peptide are used for sports drinks, health foods, etc.

After hydrolyzing the soybean milk, residue of the koji is left in the food made from the soybean milk. The residue may be left as grains or mixed by, for example, a mixer until hypha of the koji mold are cut.

On the other hand, if the residue is removed, by filtering, after the hydrolysis, the soybean milk can be made easier to drink.

After the soybean milk is hydrolyzed with the koji-derived enzyme, the soybean milk is heated so as to deactivate the enzyme and sterilize unwanted bacteria. The heat treatment may be performed for 3-60 seconds at 120-150° C.

Further, if the soybean milk, which has been heat-treated, is homogenized by, for example, a high pressure homogenizer, taste and flavor of the soybean milk can be improved.

The soybean-dairy food, which has been produced by the above described method, is sweetened by adding the koji, so that many consumers can easily have the soybean-dairy food (soybean milk).

The components of the soybean milk are formed into low-molecular components by the koji-derived enzyme and can be easily digested and absorbed in human bodies. Therefore, the soybean-dairy food produced by the above described method can be used for sports drinks, health foods, etc.

The soybean milk includes no artificial additives, e.g., artificial sweetener, so it is a natural and safe drink.

By the above described method, the effective soybean-dairy food, which is more functional than conventional food, can be easily produced.

Another method of producing soybean-dairy food will be explained.

For example, the koji may be added to the mashed soybeans, which are made in the middle of the process of producing the soybean milk, so as to perform the hydrolysis. Namely, koji is added to the mashed soybeans so as to hydrolyze the components of the mashed soybeans by koji-derived enzyme, then insoluble components, e.g., bean curd refuse, residue of the koji, are removed. By removing the insoluble components, the soybean-dairy food is completed.

The mashed soybeans are produced by soaking soybeans in water and mashing the soaked soybeans. The mashed soybeans may be heated. In the case of adding the koji to the mashed soybeans too, many kinds of koji, e.g., rice koji, barley koji, bean koji, soy sauce koji, may be used. One or a plurality of kinds of the koji may be selected. The hydrolysis may be performed under the above described conditions as well as the former method.

The soybean-dairy food (soybean milk) produced by adding the koji to the mashed soybeans has the effects as well as the soybean-dairy food produced by the former method. Namely, the soybean-dairy food produced by the present method is sweet and can be easily digested and absorbed in human bodies.

The former method includes two removing steps: (1) removing the insoluble components, e.g., bean curd refuse, to filter the soybean milk; and (2) removing residue from the soybean milk after the hydrolysis so as to improve taste.

On the other hand, in the present method, the insoluble components may be removed only once after adding the koji to the mashed soybeans for the hydrolysis. Therefore, the soybean-dairy food can be efficiently produced by the present method.

The soybean-dairy food, which has produced by adding the koji to the mashed soybeans, may be heated to deactivate the enzyme and sterilize unwanted bacteria. Further, if the heated soybean-dairy food is homogenized by, for example, a high pressure homogenizer, taste and flavor of the food can be improved.

Successively, a method of processing the soybean-dairy food, which has been produced by the above described methods, will be explained.

The method comprises the steps of: hydrolyzing the soybean milk by adding the koji to the soybean milk or the mashed soybeans; mixing dairy food into the soybean-dairy food; and inoculating lactic acid bacteria to the mixture. For example, soybean milk yogurt can be produced by the present method. Further, insoluble components may be removed from the food, and the food may be heated and/or homogenized if required.

For example, cow milk and powdered skim milk may be used as the dairy food.

Preferable lactic acid bacteria are yogurt bacteria, e.g., Lactobacillus bacteria, Streptococcus bacteria. One or a plurality of kinds of yogurt bacteria may be selected. For example, “Lactobacillus delbrueckii subsp. bulgaricus” and “Streptococcus thermophilus” are preferable.

After inoculating lactic acid bacteria, the mixture is fermented under suitable conditions for fermenting the lactic acid bacteria so as to produce the soybean milk yogurt. The soybean milk yogurt has the functions of the soybean milk (soybean-dairy food) and yogurt, so it is effective functional health food. The grassy smell of the soybean milk is further restrained by yogurt bacteria, so that mild flavor soybean milk yogurt can be provided.

The inventors performed experiments with examples of the soybean-dairy food made from the soybean milk.

### EXAMPLE 1

4 wt % of koji was added to commercially produced plain soybean milk (solid contents 10%, protein concentration 5.0%, pH value 6.57) and reacted for 3 hours at 50° C., then residue of the koji was removed by filtering. The filtered soybean milk was UHT-sterilized for 5 seconds at 145° C. and homogenized by a high pressure homogenizer.

Note that, the koji was produced by inoculating koji mold to steamed rice and growing the koji mold for 40 hours at 30-40° C.

### COMPARATIVE EXAMPLE 1

Soybean milk, to which proteolytic enzyme had been added, was prepared as a comparative example to the Example 1.

0.05 wt % of “Umamizyme” (trade name, manufactured by Amano Enzyme Co., Japan) was added to the commercially produced plain soybean milk (solid contents 10%, protein concentration 5.0%, pH value 6.57) and reacted for 3 hours at 50° C., then the soybean milk was UHT-sterilized for 5 seconds at 145° C. Further, it was homogenized by the high pressure homogenizer.

Three samples (the processed soybean milk of the Example 1 and the Comparative Example 1, and the commercially produced plain soybean milk) were sensory-tested by 9 panelists.

Grassy taste, astringent taste, bitter taste, sweet taste and comprehensive evaluation of the samples were tested. The results are shown in TABLE 1.

TABLE 1

| | | Astringent | | |
|---|---|---|---|---|
| | | Taste/Bitter | Sweet | Comprehensive |
| Samples | Grassy Taste | Taste | Taste | Evaluation |
| Example 1 | 2.7 | 2.8 | 1.2 | 3.9 |
| Plain | 2.0 | 2.6 | 2.3 | 3.0 |
| Soybean Milk | | | | |
| Comparative | 1.6 | 1.2 | 2.8 | 1.4 |
| Example 1 | | | | |

Each taste was evaluated on the basis of 3 points as follows:
1 point: clearly tasted;
2 point: slightly tasted; and
3 point: not tasted

Comprehensive Evaluation was evaluated on the basis of 5 points as follows:
1 point: Bad Taste
2 point: Rather Bad Taste
3 point: Average Taste
4. point: Rather Good Taste
5. point: Good Taste

Note that, average points of the tastes are shown in TABLE 1.

Further, palatability ranking of the samples are shown in TABLE 2.

TABLE 2

| | Number of |
|---|---|
| | Voted |
| Ranking | Panelists |
| Example 1→Plain Soybean Milk →Comparative Example 1 | 8 |
| Example 1→Comparative Example 1→ Plain Soybean Milk | 1 |

According to TABLE 1, the sample of Comparative Example 1 had little sweetness but had grassy taste, astringent taste and bitter taste. Therefore, the comprehensive evaluation of Comparative Example 1 was the lowest of all.

On the other hand, the sample of Example 1 was the sweetest of all and had no grassy taste, no astringent taste and no bitter taste. Therefore, the evaluation of Example 1 was the highest of all.

In the sample of Example 1, the grassy smell and taste of the commercially produced plain soybean milk were restrained. And, the astringent taste and bitter taste, which generate when soybean milk reacts with a proteolytic enzyme, were not sensed. On the other hand, the koji-derived sweetness was added, so that the totally balanced soybean-dairy food was produced.

According to TABLE 2, a significant difference with risk rate of 1% was observed by a ranking test. The panelists sensed that the sample of Example 1 was more delicious than others.

### EXAMPLE 2

5 wt % of rice koji was added to the commercially produced plain soybean milk, which was used in Example 1, and reacted for 2 hours at 50° C.

### EXAMPLE 3

5 wt % of rice koji was added to the commercially produced plain soybean milk, which was used in Example 1, and reacted for 6 hours at 50° C.

Amounts of isoflavones included in samples (Examples 2 and 3 and the commercially produced plain soybean milk used in Example 1) were measured, and forming aglycons was examined. The results are shown in TABLE 3. Note that, a total amount of isoflavones in each sample was 100 wt %, and amounts of components were shown in percent.

TABLE 3

| | | Plain | Example 2 | |
|---|---|---|---|---|
| | | Soybean | Time: | Example 3 |
| Isoflavones | | Milk | 2 Hours | Time: 6 Hours |
| Glycosides | Daidzin | 18.1 | 12.6 | 11.6 |
| | Genistin | 21.7 | 13.7 | 9.0 |
| | Glycitin | 3.2 | 1.8 | 2.3 |
| | Malonyldaizin | 33.5 | 37.1 | 34.4 |
| | Malonylgenistin | 19.9 | 11.3 | 15.7 |
| | Malonylglycitin | 3.6 | 2.6 | 2.6 |
| Aglycons | Daizein | 0 | 10.5 | 10.8 |
| | Genistein | 0 | 9.2 | 12.6 |
| | Glycitein | 0 | 1.1 | 1.0 |

| | | | |
|---|---|---|---|
| Total Amount of Isoflavones | 100 | 100 | 100 |

(Unit: wt %)

According to TABLE 3, aglycons of daizein, genistein and glycitein were not detected in the plain soybean milk. Furhter, isoflavones existed only in the form of glycosides and malonyl-glycosides.

On the other hand, in the samples of Examples 2 and 3 including the koji, glycosides of daidzin and genistin were hydrolyzed, so that aglycon components (daizein and genistein) were formed.

In the sample of Example 2 (2-hour hydrolysis), the amount of aglycon to the total isoflavones was about 20 wt %; in the sample of Example 3 (6-hour hydrolysis), the amount of aglycon to the total isoflavones was about 25 wt %.

### EXAMPLE 4

1 wt % of rice koji was added to the commercially produced plain soybean milk, which was used in Example 1, and reacted for 3 hours at 50° C. Then, residue of the koji was removed by filtering. The filtered liquid (soybean milk) was UHT-sterilized for 5 seconds at 145° C. and homogenized by a high pressure homogenizer. Further, 2 wt % of powdered skim milk was mixed into the soybean milk, then 0.02 wt % of yogurt bacteria (Lactobacillus delbrueckii subsp. bulgaricus and Streptococcus thermophilus) were inoculated to the mixture. The mixture was fermented for 5 hours at 43° C. By the fermentation, soybean milk yogurt was completed.

### EXAMPLE 5

Soybean milk yogurt was produced by mixing 5 wt % of rice koji into the commercially produced plain soybean milk and reacting as well as Example 4.

### EXAMPLE 6

Soybean milk yogurt was produced by mixing 10 wt % of rice koji into the commercially produced plain soybean milk and reacting as well as Example 4.

Three samples of soybean milk yogurt (Examples 4, 5 and 6) were sensory-tested. The results are shown in TABLE 4.

TABLE 4

| Samples | Amount of Koji | Sensory Evaluation |
|---|---|---|
| Example 4 | 1 wt % | Good taste; delicious with soybean |
| | | flavor and no grassy-smell |
| Example 5 | 5 wt % | Good taste; right sweetness; mild |
| Example 6 | 10 wt % | Good taste; rich flavor with |
| | | sweetness |

According to TABLE 4, rich flavor soybean milk yogurt, which had right sour taste and sweetness, could be produced by increasing the amount of koji. On the other hand, viscosity of the soybean milk yogurt was reduced by increasing the amount of koji.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing soybean-dairy food,
comprising the steps of:
mixing koji into soybean milk; and
hydrolyzing components of the soybean milk with a koji-derived enzyme.

2. A method of producing soybean-dairy food,
comprising the steps of:
adding koji to mashed soybeans;
hydrolyzing components of the mashed soybeans with a koji-derived enzyme; and
removing insoluble components.

3. The method according to claim 1,
wherein said hydrolyzing step is performed under the following conditions:
amount of the koji to total amount is 1-50 wt %;
temperature is 30-80° C.;
time of treatment is 0.5-8 hours; and
a pH value is 5-8.

4. The method according to claim 2,
wherein said hydrolyzing step is performed under the following conditions:
amount of the koji to total amount is 1-50 wt %;
temperature is 30-80° C.;
time of treatment is 0.5-8 hours; and
a pH value is 5-8.

5. The method according to claim 1,
further comprising the step of heating for 3-60 seconds at 120-150° C. so as to deactivate the enzyme and sterilize bacteria.

6. The method according to claim 2,
further comprising the step of heating for 3-60 seconds at 120-150° C. so as to deactivate the enzyme and sterilize unwanted bacteria.

7. The method according to claim 3,
further comprising the step of heating for 3-60 seconds at 120-150° C. so as to deactivate the enzyme and sterilize unwanted bacteria.

8. The method according to claim 4,
further comprising the step of heating for 3-60 seconds at 120-150° C. so as to deactivate the enzyme and sterilize unwanted bacteria.

9. Soybean-dairy food produced by the method of claim 1.

10. Soybean-dairy food produced by the method of claim 2.

11. Soybean-dairy food produced by the method of claim 7.

12. Soybean-dairy food produced by the method of claim 8.

13. Soybean-dairy food produced by the method of claim 3.

14. Soybean-dairy food produced by the method of claim 4.

15. A method of processing soybean-dairy food,
comprising the steps of:
mixing dairy food into the soybean-dairy food of claim 11;
inoculating lactic acid bacteria to the mixture; and
fermenting the mixture.

16. A method of processing soybean-dairy food,
comprising the steps of:
mixing dairy food into the soybean-dairy food of claim 12;
inoculating lactic acid bacteria to the mixture; and
fermenting the mixture.

17. A method of processing soybean-dairy food,
comprising the steps of:
mixing dairy food into the soybean-dairy food of claim 13;
inoculating lactic acid bacteria to the mixture; and
fermenting the mixture.

18. A method of processing soybean-dairy food,
comprising the steps of:
mixing dairy food into the soybean-dairy food of claim 14;
inoculating lactic acid bacteria to the mixture; and
fermenting the mixture.

19. A method of processing soybean-dairy food,
comprising the steps of:
mixing dairy food into the soybean-dairy food of claim 9;
inoculating lactic acid bacteria to the mixture; and
fermenting the mixture.

20. A method of processing soybean-dairy food,
comprising the steps of:
mixing dairy food into the soybean-dairy food of claim 10;
inoculating lactic acid bacteria to the mixture; and
fermenting the mixture.
